(19) United States
(12) Patent Application Publication
(10) Pub. No.: US 2006/0038806 A1
(43) Pub. Date: Feb. 23, 2006

(54) Plasma display and driving method thereof

(76) Inventor: Jae-Seok Jeong, Suwon-si (KR)

Correspondence Address: MCGUIREWOODS, LLP, 1750 TYSONS BLVD, SUITE 1800, MCLEAN, VA, 22102, US

(21) Appl. No.: 11/205,032

(22) Filed: Aug. 17, 2005

(30) Foreign Application Priority Data
Aug. 18, 2004 (KR) 10-2004-0065062
Aug. 18, 2004 (KR) 10-2004-0065063
Aug. 18, 2004 (KR) 10-2004-0065064

(51) Int. Cl. G09G 5/00

(52) U.S. Cl. 345/204

(57) ABSTRACT

In a plasma display, pairs of first and second electrodes are divided into groups. In a subfield, a light-emitting cell is set from among discharge cells of a first group from among the groups, and the light-emitting cell is sustain-discharged for a first number of times. A light-emitting cell is set from among discharge cells of a second group, and the light-emitting cell is sustain-discharged for a first number of times. The light-emitting cell of the first group is sustain-discharged for a second number of times, and the light-emitting cell of the second group is sustain-discharged for a third number of times. The sum of the first number and the second number equals the third number so that the light-emitting cells of the first and second groups are sustained discharged for an equal number of times.

### CROSS-REFERENCE TO RELATED APPLICATION

This application claims priority to and the benefit of Korean Patent Applications Nos. 10-2004-0065062, 10-2004-0065063, and 10-2004-0065064, filed in the Korean Intellectual Property Office on Aug. 18, 2004, the entire contents of which are incorporated herein by reference.

### BACKGROUND OF THE INVENTION

(a) Field of the Invention

The present invention relates to a plasma display and a driving method thereof.

(b) Description of the Related Art

A plasma display is a flat panel display that uses plasma generated by gas discharge to display characters or images. A display panel of the plasma display may include up to millions of pixels arranged in a matrix pattern.

In general, one frame in the plasma display is divided into a plurality of subfields of varying brightness weights. Grayscales of discharge cells are determined by a summation of subfield weights. In general, each subfield may include a reset period, an address period, and a sustain period. In the reset period, discharge cells are reset to clear any wall charges. In the address period, an address operation is performed to identify light-emitting cells and non light-emitting cells from among the discharge cells. In the sustain period, the addressed cells are sustain-discharged during a period according to corresponding subfield weights to thus display images. In the address period, scan pulses are sequentially applied to scan electrodes to sequentially perform the address operation. The light-emitting cells are then sustain-discharged in the sustain period after being addressed in the address period.

Some scan electrodes to which the address operation is initially performed, however, are sustain-discharged well after they are addressed. This may result in unstable sustain-discharging of these initially addressed cells because the predetermined amount of priming particles generated by the address operation and/or wall charges formed on these discharge cells may be diminished before a sustain discharge is finally generated.

The information disclosed in this Background of the Invention section is only for enhancement of understanding of the invention and therefore, unless explicitly described to the contrary, it should not be taken as an acknowledgement or any form of suggestion that this information forms the prior art that is already known in this country to a person of ordinary skill in the art.

### SUMMARY OF THE INVENTION

The present invention has been made in an effort to provide a plasma display and a driving method thereof having advantages of reducing the time between an address operation and a sustain discharge operation.

A method for driving a plasma display according to the present invention, the plasma display includes a plurality of first electrodes and a plurality of second electrodes arranged in pairs extending along a first direction such that each pair includes a first electrode and a second electrode; a plurality of third electrodes extending along a second direction substantially perpendicular to the first direction; and a plurality of discharge cells formed by the crossing of the first and second electrode pairs and the third electrodes. The driving method includes: dividing the pairs of first and second electrodes into a plurality of groups such that the plurality of groups includes at least a first group and a second group; dividing a display frame into a plurality of subfields; dividing the subfields into a plurality of sustain periods and a plurality of address periods such that each sustain period and each address period correspond to one group of the plurality of groups; selecting light-emitting cells from among the discharge cells of each group in the corresponding address period; applying first and second sustain pulses to each of the first electrode and the second electrode in each sustain period. The starting point of at least one of the plurality of sustain periods is provided between two adjacent address periods. The first and second sustain pulses applied to the first and second electrodes of the first group include a high level pulse and a low level pulse with opposite phases in a first sustain period of the plurality of sustain periods, and the first sustain pulse applied to one of the first and second electrodes of the first group does not include one of the high level pulse or the low level pulse in a second sustain period.

In another embodiment, a method for driving a plasma display, the plasma display includes a plurality of first electrodes and a plurality of second electrodes arranged in pairs extending along a first direction such that each pair includes a first electrode and a second electrode, a plurality of third electrodes extending along a second direction substantially perpendicular to the first direction, and a plurality of discharge cells formed by the crossing of the first and second electrode pairs and the third electrodes. The driving method includes: dividing the pairs of first and second electrodes into a plurality of groups; setting light emitting cells from among discharge cells of a first group of the plurality of groups; sustain-discharging the light-emitting cells of the first group for a first number of times; setting light-emitting cells from among discharge cells of a second group of the plurality of groups; sustain-discharged the light-emitting cells of the second group for a second number of times; sustain-discharging the light-emitting cells of the first group for a third number of times; and sustain-discharging the light-emitting cells of the second group for a fourth number of times. The sum of the first number and the third number equals the sum of the second number and the fourth number so that the light-emitting cells of the first and second groups are sustain-discharged an equal number of times.

The invention also provides a plasma display that includes: a plurality of first electrodes; a plurality of selection circuits, each having a first terminal and a second terminal, coupled to corresponding first electrodes and selectively transmitting inputs provided by the first and second terminals to the corresponding first electrode, the plurality of selection circuits are divided into a plurality of groups; a first switch that has a first terminal coupled to a first power supply providing a first voltage for a sustain discharge, and has a second terminal coupled to second terminals of the selection circuits through an electrical path; a second switch that has a first terminal coupled to a second power supply providing a second voltage for a sustain discharge, and has a second terminal coupled to the second terminals of the selection circuits through the electrical path; a third switch coupled between the first terminals of the selection circuit of the first group and the first power supply.

In another embodiment, a plasma display includes: a plurality of first electrodes divided into a plurality of groups including at least a first group and a second group; a first switch that has a first terminal coupled to the first electrodes of the first group; a sustain driver that has an output terminal coupled both to the first terminal of the first switch and the first electrodes of the second group, the sustain driver alternately outputs a first voltage and a second voltage in a sustain period; and a second switch that has a first terminal coupled to the first electrodes of the first group and a second terminal coupled to a power supply of the sustain driver.

### BRIEF DESCRIPTION OF THE DRAWINGS

FIG. 1 shows a plasma display according to an embodiment of the present invention.

FIG. 2 shows a table for a plasma display driving method according to an embodiment of the present invention.

FIG. 3 shows a subfield for the plasma display driving method according to an embodiment of the present invention.

FIG. 4 shows driving waveforms for the plasma display driving method according to an embodiment of the present invention.

FIG. 5 and FIG. 6 show schematic circuit diagrams of scan electrode drivers for generating the driving waveforms of FIG. 4.

FIG. 7 shows driving waveforms for the plasma display driving method according to another embodiment of the present invention.

FIG. 8 shows a schematic circuit diagram of a scan electrode driver for generating the driving waveforms of FIG. 7.

FIG. 9 shows driving waveforms for the plasma display driving method according to yet another embodiment of the present invention.

FIG. 10 shows a schematic circuit diagram of a sustain electrode driver for generating the driving waveforms of FIG. 9.

### DETAILED DESCRIPTION

In the following detailed description, only certain exemplary embodiments of the present invention have been shown and described. As those skilled in the art would realize, the described embodiments may be modified in various ways, all without departing from the spirit or scope of the present invention. Accordingly, the drawings and accompanying description are to be regarded as illustrative, rather than restrictive, in nature. Like reference numerals designate like elements throughout the specification.

Plasma display driving methods according to embodiments of the present invention will be described in detail with reference to drawings.

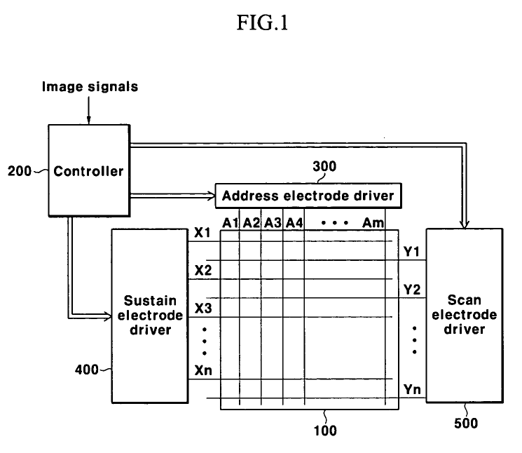

A plasma display according to an embodiment of the present invention will now be described with reference to FIG. 1.

As shown in FIG. 1, the plasma display includes a plasma display panel (PDP) 100, a controller 200, an address electrode driver 300, a sustain electrode driver 400, and a scan electrode driver 500. PDP 100 includes a plurality of address electrodes A₁-Aₘ arranged in columns, and a plurality of sustain electrodes X₁-Xₙ and scan electrodes Y₁-Yₙ arranged in rows of parallel pairs. Discharge cells are formed by the pairs of scan and sustain electrodes crossing the address electrodes.

Controller 200 receives external video signals and generates an address electrode driving control signal, a sustain electrode driving control signal, and a scan electrode driving control signal. Controller 200 divides one frame into a plurality of subfields of varying weights and drives PDP 100.

Address electrode driver 300 receives the address electrode driving control signal from controller 200, and applies a signal to the address electrodes A₁-Aₘ for selecting a discharge cell to be displayed. Sustain electrode driver 400 receives the sustain electrode driving control signal from controller 200 and applies a driving voltage to the sustain electrodes X₁-Xₙ, and scan electrode driver 500 receives the scan electrode driving control signal from controller 200 and applies a driving voltage to the scan electrodes Y₁-Yₙ.

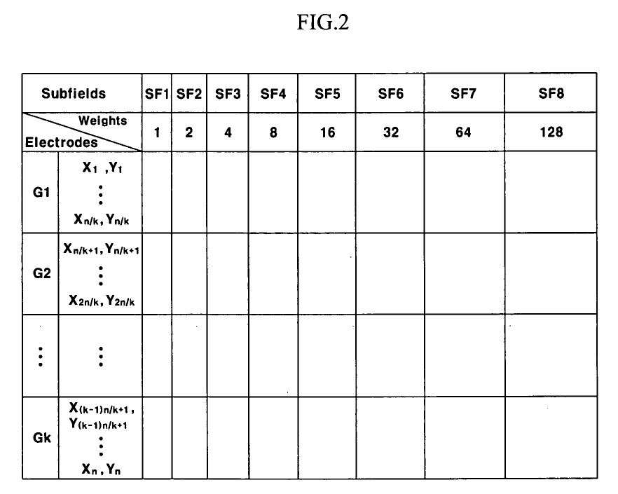

A plasma display driving method according to an embodiment of the present invention will now be described with reference to FIG. 2 to FIG. 4.

As shown in FIG. 2, one frame is divided into subfields SF1-SF8 of varying subfield weights. The scan electrodes Y₁-Yₙ and the sustain electrodes X₁-Xₙ are divided into k number of groups G1-Gk (where k is an integer of at least 2). The scan and sustain electrodes Y₁-Yₙ and X₁-Xₙ are gathered into a predetermined number of groups in a predetermined order. For example, the scan and sustain electrodes Y₁-Y_{n/k} and X₁-X_{n/k} from the first row to the (n/k)^{th} row form the first group G1, and the scan and sustain electrodes Y_{n/k+1}-Y_{2n/k} and X_{n/k+1}-X_{2n/k} from the (n/k+1)^{th} row to the (2n/k)^{th} row form the second group G2. Similarly, the scan and sustain electrodes Y_{(k-1)n/k+1}-Yₙ and X_{(k-1)n/k+1}-Xₙ from the ((k−1)n/k+1)^{th} row to the n^{th} row form the k^{th} group Gk.

In an alternative arrangement, the scan and sustain electrodes pairs Y₁-Yₙ and X₁-Xₙ separated by a constant gap therebetween can be grouped together. That is, the first pairs of scan and sustain electrodes (Y₁X₁, Y_{n/k+1}X_{n/k+1}, Y_{2n/k+1}X_{2n/k+1} . . . Y_{(k-1)n/k+1}X_{(k-1)n/k+1}) are set to be the first group G1, and the second pairs of scan and sustain electrodes (Y₂X₂, Y_{n/k+2}X_{n/k+2}, Y_{2n/k+2}X_{2n/k+2} . . . Y_{(k-1)n/k+2}X_{(k-1)n/k+2}) are set to be the second group G2. If necessary, the pairs of scan and sustain electrodes can be grouped in a random manner.

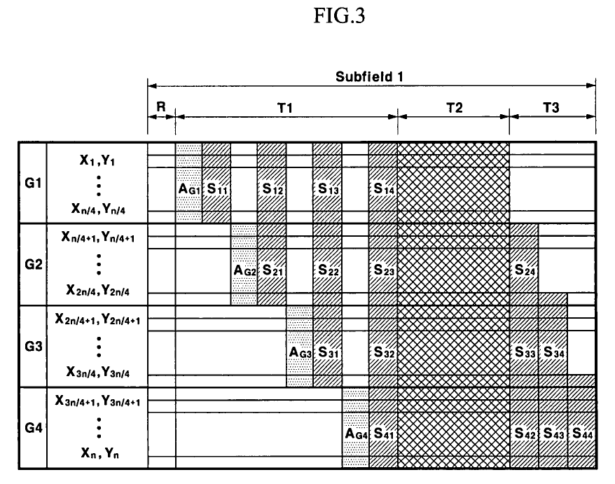

FIG. 3 shows a subfield for the plasma display driving method according to an embodiment of the present invention. For purposes of illustration, the pairs of scan and sustain electrodes Y₁-Yₙ and X₁-Xₙ are divided into four groups G1, G2, G3, and G4. It is assumed that all the sustain periods (S₁₁ to S₄₄) have approximately the same length.

As shown in FIG. 3, the subfield has a reset period R, a combined address/sustain period T1, a common sustain period T2, and a brightness correction period T3.

In the reset period R, a reset waveform is applied to the discharge cells of the groups G1 to G4 to reset the wall charges of the discharge cells.

In the combined address/sustain period T1, an address operation is performed on discharge cells in the first group G1 during address period A_{G1} to select light-emitting cells, and subsequently a sustain operation is applied to provide sustain discharge in the selected cells of group G1 during sustain period S₁₁. Next, an address operation is performed on discharge cells in the second group G2 during address period A_{G2} to select light-emitting cells, which is followed by a sustain operation that is applied to provide sustain discharge in the selected cells of the first and the second groups G1 and G2 during sustain periods S₁₂ and S₂₁, respectively. Then, an address operation is performed to select discharge cells in the third group G3 during address period A_{G3}, and again a sustain operation is applied provide sustain discharge in selected cells of groups G1, G2, and G3 during sustain periods S₁₃, S₂₂, and S₃₁. In a similar manner, an address operation is applied to discharge cells in the fourth group G4 in address period A_{G4} to set the light-emitting cells, and a sustain operation is applied during sustain periods S₁₄, S₂₃, S₃₂, and S₄₁ to provide sustain discharge in the selected light-emitting cells in groups G1 to G4.

In the common sustain period T2, a sustain operation is applied in common for a predetermined time to provide sustain discharge in the light-emitting cells of the groups G1 to G4. Brightness weights of corresponding subfields are set by controlling the length of the common sustain period T2.

When the operations of the combined address/sustain period T1 and the common sustain period T2 are performed as described above, the number of sustain operations applied to light-emitting cells in each group may vary, which leads to corresponding variance in brightness of cells in groups G1, G2, G3, and G4.

To compensate for this brightness variance, a brightness correction operation during period T3 is applied so as to correct the brightness differences of the respective groups. In the brightness correction period T3, sustain discharge operations are applied so that the same number of sustain discharges is generated at each of the light-emitting cells in groups G1, G2, G3, and G4.

Accordingly, a sustain operation is applied during sustain periods S₂₄, S₃₃, and S₄₂ to provide sustain discharge in the light-emitting cells of groups G2, G3 and G4 while light-emitting cells of group G1 may not be sustain-discharged. Subsequently, sustain operations are applied to light-emitting cells in group G3 during sustain period S₃₄ and to light-emitting cells in group G4 during sustain periods S₄₃ and S₄₄. Accordingly, the same number of sustain discharges have been generated for each of the light-emitting cells over subfield 1.

It is illustrated in FIG. 3 that the brightness correction operation of period T3 is performed after the common sustain period T2, but it is also possible that brightness correction can be performed before the common sustain period T2. Also, the common sustain operation of period T2 may not be performed when the brightness weight of the corresponding subfield is satisfied by the sustain discharge provided in the address/sustain period T1 and the brightness correction period T3. For example in FIG. 3, when a light-emitting cell of the group G1 expresses a desired grayscale by one operation of the sustain period S₁₁, a light-emitting cell of group G1 is set to generate no sustain discharges during the subsequent three sustain periods S₁₂, S₁₃, and S₁₄. Further, the light-emitting cell of second group G2 is set to generate no sustain discharges for the subsequent sustain periods S₂₂ and S₂₃, or sustain discharge S₂₄ in period T3. In addition, the brightness correction period T3 can be included in the combined address/sustain period T1.

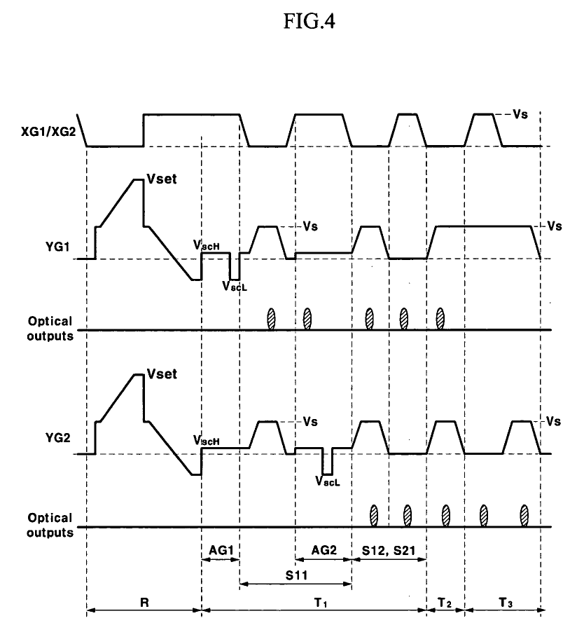

Driving waveforms for realizing the plasma display driving method according to the present invention and driving circuits for generating the driving waveforms will now be described with reference to FIG. 4 to FIG. 10.

FIG. 4 shows driving waveforms for the plasma display driving method according to an embodiment of the present invention. It is illustrated for ease of description in FIG. 4 that the scan and sustain electrodes Y₁-Yₙ and X₁-Xₙ are combined into two groups. The scan electrodes of the two groups are illustrated as YG1 and YG2, and the sustain electrodes of the two groups are illustrated as XG1 and XG2, which have the same voltage waveform. The driving waveform applied to the address electrode is omitted in FIG. 4.

In the reset period R, a reset waveform is applied to the scan electrodes of the first and second groups YG1 and YG2 to reset the wall charges of the discharge cell. The voltages applied to the scan electrodes YG1 and YG2 are gradually increased from Vs to Vset while a reference voltage (e.g., the ground voltage in FIG. 4) is applied to the sustain electrodes. The voltages applied to the scan electrodes YG1 and YG2 are gradually reduced from the voltage of Vs to the voltage of VscL while the voltage of Vs is applied to the sustain electrodes XG1 and XG2. In this manner, the wall charges of the discharge cells of the first and second groups can be reset.

In the combined address/sustain period T1, an address operation is performed on the scan and sustain electrodes YG1 and XG1 of the first group during the address period AG1. In the address period AG1, a scan pulse of voltage VscL is sequentially applied to the scan electrodes YG1 of the first group while the voltage of Vs is applied to the sustain electrodes XG1 and XG2 of the first and second groups. In this instance, the voltage of VscH, which is higher than the voltage of VscL, is applied to the scan electrodes of YG2 and scan electrodes YG1 of the first group to which no scan pulse is applied. A discharge occurs at the discharge cell formed where the scan electrodes YG1 to which the scan pulse is applied cross the address electrode to which an address pulse (not shown) is applied. In the discharge cell, also known as a light-emitting cell, positive wall charges are formed at the scan electrode YG1 and negative wall charges are formed at the sustain electrode XG1 so that a predetermined wall voltage of Vwxy is formed between the scan and sustain electrodes such that the discharge cell is selected as a light-emitting cell. Here, light-emitting cells are not selected from discharge cells of the second group because the voltage of VscH is continually applied to the scan electrode YG2 during period AG1 to thus generate no wall charges.

In sustain period S₁₁, a sustain pulse in the opposite phase is applied to the scan electrodes YG1 and YG2 and the sustain electrodes XG1 and XG2. It is illustrated in FIG. 4 that a single sustain pulse is applied. The sustain pulse has a high level voltage and a low level voltage 0V or VscH. In this instance, the voltage of Vs or (Vs-VscH) is given to be less than a firing voltage between the scan electrode and the sustain electrode. Also, the sum of the voltage of Vs or (Vs-VscH) and the wall voltage Vwxy in the address period AG1 is set to be greater than the firing voltage.

When the voltage of Vs is applied to the scan electrodes YG1 and YG2 and a ground voltage (0V) is applied to the sustain electrodes XG1 and XG2 in the sustain period S₁₁, the discharge cells of the first groups YG1 and XG1 having the wall voltage Vwxy are sustain-discharged. Subsequently, a wall voltage of Vwyx with the opposite polarity of the wall voltage of Vwxy during address period AG1 is formed between the scan electrode YG1 and the sustain electrode XG1 of the light emitting cell. Further, no sustain discharge occurs when the sustain pulse is applied to the scan and sustain electrodes YG2 and XG2 of the second group since no wall voltage has been formed between the scan electrode YG2 and the sustain electrode XG2. Next, the voltage of VscH is applied to the scan electrodes YG1 and YG2 and the voltage of Vs is applied to the sustain electrodes XG1 and XG2 so that the discharge cells of the first group having wall voltage of Vwyx are again sustain-discharged. As a result, positive wall charges are formed at the scan electrode YG1 and the negative wall charges are formed at the sustain electrode XG1 by the above-noted sustain discharge so that a wall voltage of Vwxy′ with the same polarity as that of the voltage of Vwxy is formed between the scan electrode YG1 and the sustain electrode XG1 of light-emitting cells.

An address operation in period AG2 is performed on the scan and sustain electrodes YG2 and XG2 of the second group. A scan pulse of voltage VscL is sequentially applied to the scan electrode YG2 while the voltage of Vs is applied to the sustain electrodes XG1 and XG2. Now, the voltage of VscH is applied to the scan electrodes of the first group YG1 and the scan electrodes of the second group YG2 to which no scan pulse is applied. The discharge cell formed where the scan electrodes YG2 to which the scan pulse is applied cross the address electrode to which the address pulse (not shown) is applied is then discharged. As described above, the wall voltage of Vwxy is formed between the scan electrode YG2 and the sustain electrode XG2 such that the discharge cell is selected as a light-emitting cell. Therefore, the light-emitting cells are selected from among the discharge cells formed by the scan and sustain electrodes of the second group YG2 and XG2 during address period AG2.

Next, in the sustain periods S₁₂ and S₂₁, a sustain pulse is applied in the opposite phase to the scan electrodes YG1 and YG2 and the sustain electrodes XG1 and XG2. The voltage of 0V is applied to the sustain electrodes XG1 and XG2 and the voltage of Vs is applied to the scan electrodes YG1 and YG2. The light-emitting cells of the first and second groups are sustain-discharged since the positive wall charges are formed in the light-emitting cells of the first and second groups. The light-emitting cells of both the first and second groups are then sustain-discharged when the voltage of Vs is applied to the sustain electrodes XG1 and XG2 and a ground voltage (0V) is applied to the scan electrodes YG1 and YG2.

In the common sustain period T2, a sustain pulse is applied in common to the scan electrodes YG1 and YG2 and the sustain electrodes XG1 and XG2 to sustain-discharge the light-emitting cells of the first and second groups.

Since the light-emitting cells of the first group have been sustain-discharged two more times than the light-emitting cells of the second group, a brightness correction operation during period T3 is performed on light-emitting cells of the second group. Thus, the voltage of Vs is concurrently applied to the scan electrodes YG1 and the sustain electrodes XG1 while the negative wall charges are formed at the scan electrodes YG1 and YG2 by a previous sustain discharge. Also, a ground voltage (0V) is applied to the scan electrodes YG2 while the voltage of Vs is applied to the sustain electrodes XG2. Accordingly, the light-emitting cells of the second group are sustain-discharged by the voltage difference of Vs applied between the scan electrodes YG2 and the sustain electrodes XG2. However, no sustain discharge is generated at the light-emitting cells of the first group since the voltage difference applied between the scan electrode YG1 and the sustain electrode XG1 is 0V.

Next, the voltage of Vs is applied to the scan electrodes YG1 and YG2 of the first and second groups and 0V is applied to the sustain electrodes XG1 and XG2. Here, the light-emitting cells of the first group are not sustain-discharged due to the negative wall charges formed at the scan electrode YG1. When 0V is applied to the scan electrode YG1 and the voltage of Vs is applied to the sustain electrode XG1, however, the light-emitting cell of the first group could be sustain-discharged but that is not illustrated in FIG. 4. Accordingly, in the brightness correction operation of period T3, the brightness of the light-emitting cells of the first group and the second group is controlled such that an equal number of sustain discharges are performed on light-emitting cells in both groups.

It is illustrated further in FIG. 4 that address period AG2 overlaps sustain period S₁₁ and the voltage of Vs is applied to the sustain electrodes XG1 and XG2 when the voltage of VscH is applied to the scan electrodes YG1 and YG2. In addition, it is also possible to separate the two periods S11 and AG2 and apply not the voltage of VscH but a ground voltage (0V) to the scan electrode. Also, it is possible to apply the voltage of Vb, which is greater or less than the voltage of Vs, to the sustain electrodes XG1 and XG2 rather than the voltage of Vs during the reset period R and the address periods AG1 and AG2.

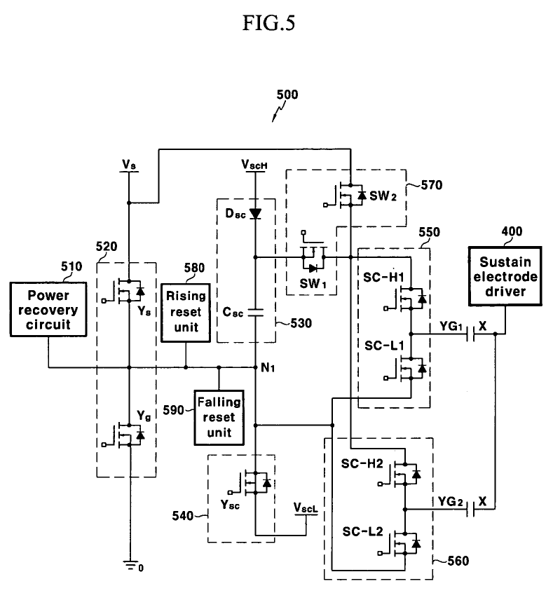

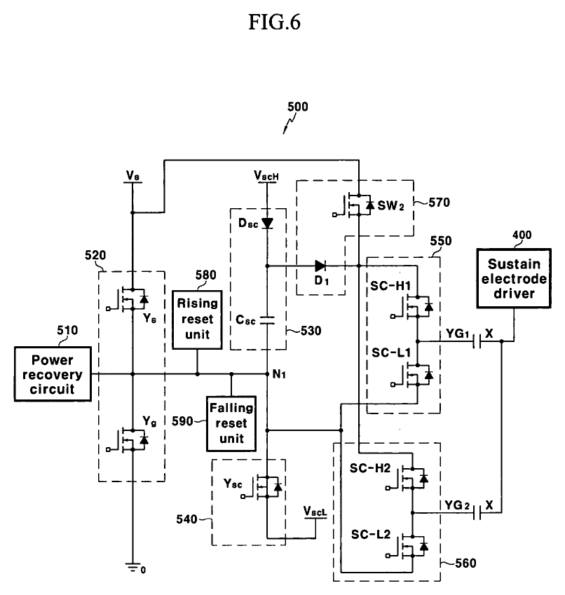

FIG. 5 and FIG. 6 show schematic circuit diagrams of a scan electrode driver 500 for generating the driving waveforms of FIG. 4. For illustrative purposes, FIG. 5 shows that one of the sustain and scan electrodes XG1 and YG1 of the first group and one of the sustain and scan electrodes XG2 and YG2 of the second group are provided. Also, NMOS transistors are used for switches to form body diodes in FIG. 5, and other types of switches are also applicable.

Scan electrode driver 500 includes a power recovery circuit 510, a sustain driver 520, a VscH voltage supply 530, a VscL voltage supply 540, a first-group selection circuit 550, a second-group selection circuit 560, a brightness corrector 570, a rising reset unit 580, and a falling reset unit 590.

One first-group selection circuit 550 is illustrated to be coupled to one scan electrode YG1 in FIG. 5 even though a plurality of first-group selection circuits 550 are formed to correspond with the number of first-group scan electrodes YG1. In a like manner, one second-group selection circuit 560 is illustrated to be coupled to one scan electrode YG2 in FIG. 5 even though a plurality of second-group selection circuits 560 are formed to correspond with the number of second-group scan electrodes YG2. Selection circuit 550 of the first group includes a transistor SC-H1 having a source coupled to the scan electrode YG1 and a transistor SC-L1 having a drain coupled to the scan electrode YG1, and selection circuit 560 of the second group includes a transistor SC-H2 having a source coupled to the scan electrode YG2 and a transistor SC-L2 having a drain coupled to the scan electrode YG2. Sources of transistors SC-L1 and SC-L2 of selection circuits 550 and 560 of the first and second groups are coupled to a node N1.

VscH voltage supply 530 includes a capacitor Csc having a first terminal coupled to a power supply for supplying the voltage of VscH and a second terminal coupled to the node N1. VscH voltage supply 530 may further include a diode Dsc for preventing current from flowing from the capacitor Csc to the power supply VscH. VscL voltage supply 540 includes a transistor Ysc coupled between the node N1 and a power supply for supplying the voltage of VscL. The capacitor Csc is charged with the voltage of VscH-VscL when the transistor Ysc is turned on.

Sustain driver 520 includes transistors Ys and Yg and outputs a sustain pulse through an output terminal. The transistor Ys has a drain coupled to a power supply for supplying the voltage of Vs and a source coupled to the node N1 through an electrical path. The transistor Yg has a source coupled to a power for supplying a ground voltage (0V) and a drain coupled to the node N1 through an electrical path. Rising reset unit 580, for gradually increasing the voltage at the scan electrode in the reset period, and falling reset unit 590, for gradually reducing the voltage at the scan electrode in the reset period, are coupled to an electrical path with transistors Ys and Yg and node N1. An element (not illustrated) such as a transistor is formed on this electrical path to prevent the short state that may occur between the drivers coupled to the electrical path.

Brightness corrector 570 includes transistors SW1 and SW2. The transistor SW1 is coupled between the first terminal of the capacitor Csc and drains of the transistor SC-H1 and SC-H2 of the first and second group selection circuits 550 and 560. The transistor SW2 is coupled between the power supply Vs and the drains of the transistor SC-H1 and SC-H2 of selection circuits 550 and 560.

Power recovery circuit 510 increases the voltages at the scan electrodes YG1 and YG2 through resonance before applying the voltage of Vs to the scan electrodes YG1 and YG2, and decreases the voltages at the scan electrodes YG1 and YG2 through resonance before applying 0V to the scan electrodes YG1 and YG2.

An operation of the driving circuit of FIG. 5 will now be described with reference to FIG. 4.

In the first group address period AG1 of the combined address/sustain period T1, the transistors SC-H1 and SC-H2 and the transistor YscL are turned on. The voltage at the node N1 becomes VscL, and the voltage of VscH is applied to the scan electrodes YG1 and YG2 because of the voltage of VscH-VscL charged in the capacitor Csc. In this instance, the transistor SC-H1 coupled to a scan electrode YG1 to be selected for displaying an image from among the scan electrodes of the first group is turned off and the transistor SC-L1 is turned on so that the voltage of VscL is applied to the selected scan electrode YG1.

The transistor Ysc and the transistors SC-H1 and SC-H2 are turned off in the sustain period S₁₁. The transistors SC-L1 and SC-L2 and the transistor Ys are turned on so that the voltage of Vs is applied to the scan electrodes YG1 and YG2. The transistor Ys is then turned off and the transistor Yg is turned on so that a ground voltage (OV) may be applied to the scan electrodes YG1 and YG2.

In the second group address period AG2, the transistors SC-H1 and SC-H2 and the transistor Ysc are turned on so that the voltage of VscH is applied to the scan electrodes YG1 and YG2, in a manner similar to that of address period AG1. Here, the transistor SC-H2 coupled to a scan electrode YG2 to be selected for displaying an image from among the scan electrodes of the second group is turned off and the transistor SC-L2 is turned on so that the voltage of VscL is applied to the selected scan electrode YG2.

In the sustain periods S₁₂ and S₂₁ and the common sustain period T2, the transistors SC-H1 and SC-H2 are turned off, and the transistors SC-L1 and SC-L2 are turned on. The two transistors Ys and Yg of the sustain driver 520 are alternately turned on and off so that the voltages of Vs and 0V are alternately applied to the scan electrodes YG1 and YG2. During the above-described combined address/sustain period T1 and the common sustain period T2, the transistor SW1 is turned on and the transistor SW2 is turned off.

During brightness correction period T3, the transistor Yg is turned on to apply 0V to the node N1. In this case, the transistor SC-L1 is turned off and the transistor SC-H1 is turned on while the transistor SC-L2 is turned on. The transistor SW1 is turned off and the transistor SW2 is turned on. Then, 0V is applied to the scan electrode YG2 through the transistor SC-L1 to perform a normal sustain discharge, and the voltage of Vs is applied to the scan electrode YG1 through the transistors SW2 and SC-H1 to generate no sustain discharges.

Next, the transistors SW2 and SC-H1 are turned off and the transistors Ys, SC-L1, and SC-L2 are turned on so that the voltage of Vs is applied to the scan electrodes YG1 and YG2. In this instance, no sustain discharges occur at scan electrode YG1 as it still has a wall voltage with an inverted polarity because sustain discharges were generated at the scan electrode YG1 in the prior brightness correction operation of period T3.

Transistor SW1 prevents the voltage of Vs from being applied to the capacitor Csc when the transistor SW2 is turned on to transmit the voltage of Vs to the transistor SC-H1. Further, other elements performing the same function as that of the transistor SW1 can be used, which will be described with reference to FIG. 6.

FIG. 6 shows an alternative schematic circuit diagram of the scan electrode driver 500 for generating the driving waveforms of FIG. 4. The only difference from the scan electrode driver of FIG. 5 is that a diode D1 is used instead of the transistor SW1. Therefore, the diode D1 transmits the voltage of VscH to the selection circuits 550 and 560 during the address periods AG1 and AG2, and prevents the voltage of Vs from being applied to the capacitor Csc during the brightness correction period T3.

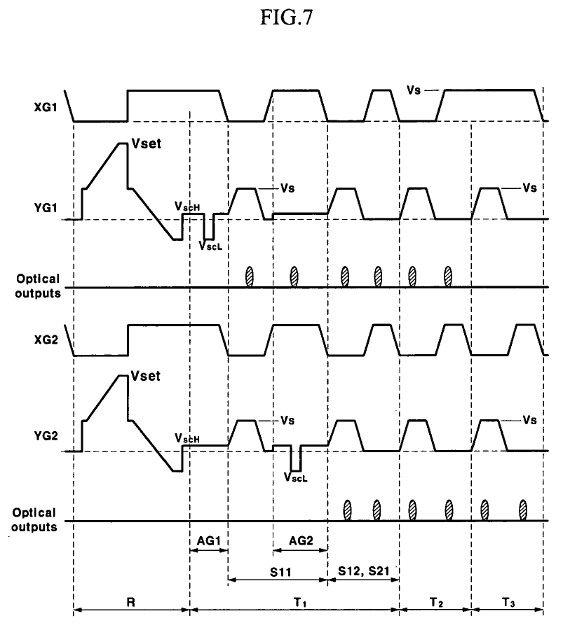

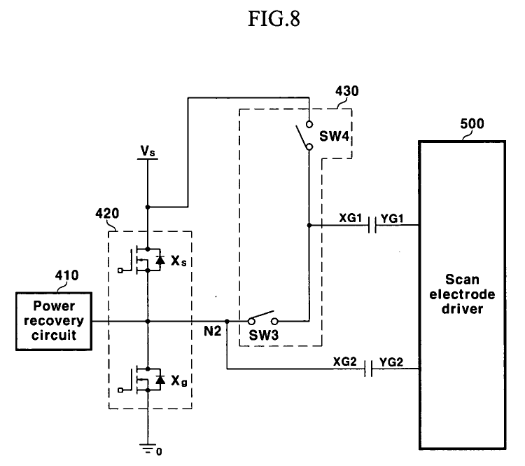

In summary, the brightness may be corrected by applying the voltage of Vs to the scan electrode of at least one group when the voltage of Vs is applied to the sustain electrodes of all groups during brightness correction period T3 according to an embodiment of the present invention. In another embodiment of the present invention, the brightness can be corrected by applying the voltage of Vs to the sustain electrode of at least one group when the voltage of Vs is applied to the scan electrodes of all groups. Another embodiment of the present invention will be described in detail with reference to FIG. 7 and FIG. 8.

As shown in FIG. 7, the driving waveforms are similar to those illustrated in FIG. 4, thus, only the brightness correction operation of period T3 will be described in detail.

During the brightness correction period T3, the voltage of Vs is concurrently applied to the scan electrodes YG1 and the sustain electrodes XG1 while the previous sustain discharge formed positive wall charges at the scan electrodes YG1 and YG2. At the same time, the voltage of Vs is applied to the scan electrodes YG2 and 0V is applied to the sustain electrodes XG2 of the second group. As a result, the light-emitting cells of the second group are sustain-discharged and the light-emitting cells of the first group are not sustain-discharged as in the previously described embodiment.

Next, 0V is applied to the scan electrodes YG1 and YG2 and the voltage of Vs is applied to the sustain electrodes XG1 and XG2. In this instance, the light-emitting cells of the first group are not sustain-discharged when 0V is applied to the scan electrode YG1 because of the positive wall charges that were formed thereon. Though not shown here, the light-emitting cells of the first group can be sustain-discharged when the voltage of Vs is applied to the scan electrode YG1 and 0V is applied to the sustain electrode XG1.

FIG. 8 shows a schematic circuit diagram of the sustain electrode driver 400 for generating the driving waveforms of FIG. 7. As shown in FIG. 8, the sustain electrode driver 400 includes a power recovery circuit 410, a sustain driver 420, and a brightness corrector 430.

Brightness corrector 430 includes switches SW3 and SW4. The switch SW3 is coupled between the sustain electrode XG1 and the node N2, and the switch SW4 is coupled between the power supply Vs and the sustain electrode XG1. The sustain electrode XG2 is coupled to the node N2. Sustain driver 420 includes a transistor Xs coupled between the power supply Vs and the node N2 as well as a transistor Xg coupled between the power supply 0 and the node N2. Power recovery circuit 410 increases the voltages at the sustain electrodes XG1 and XG2 through resonance before applying the voltage of Vs to the sustain electrodes XG1 and XG2, and decreases the voltages at the sustain electrodes XG1 and XG2 through resonance before applying 0V to the sustain electrodes XG1 and XG2.

In the reset period R and the address periods AG1 and AG2, a transistor can be provided and coupled between a power supply for supplying the voltage of Vb (not shown) which is different from the voltage of Vs, and the node N2 for applying the voltage of Vb to the sustain electrodes XG1 and XG2. Also, a driving circuit having the structure described in FIG. 5 and FIG. 6, except for brightness corrector 570, can be used as the scan electrode driver 500.

An operation of the driving circuit of FIG. 8 will now be described with reference to FIG. 7.

In the combined address/sustain period T1 and the common sustain period T2, the switch SW3 is turned on and the transistor SW4 is turned off. In the address period AG1, the transistor Xs is turned on and the voltage of Vs is applied to the sustain electrodes XG1 and XG2 through switch SW3. In the sustain period S₁₁, the transistor Xs is turned off and the transistor Xg is turned on so that 0V is applied to the sustain electrodes XG1 and XG2 through the switch SW3. Next, the transistor Xg is turned off and the transistor Xs is turned on so that the voltage of Vs is applied to the sustain electrodes XG1 and XG2. In the address period AG2, the transistor Xg is turned off and the transistor Xs remains on so that the voltage of Vs is applied to the sustain electrodes XG1 and XG2. In the sustain periods S₁₂ and S₂₁ and the common sustain period T2, the two transistors Xg and Xs are alternately turned on and off so that the voltages of 0V and Vs are alternately applied to the sustain electrodes XG1 and XG2. During the brightness correction period T3, the transistor Xg is turned on to apply 0V to the node N2. At this time, the switch SW3 is turned off and the switch SW4 is turned on. Then, 0V is applied to the sustain electrode YG2 through the node N2 to perform a normal sustain discharge, and the voltage of Vs is applied to the sustain electrode XG1 through the switch SW4 to generate no sustain discharges.

Subsequently, the transistor Xg and the switch SW4 are turned off and the transistor Xs and the switch SW3 are turned on so that the voltage of Vs is applied to the sustain electrodes XG1 and XG2. No sustain discharges occur at the scan electrode XG1 of the first group because of the wall voltage of inverted polarity as no sustain discharges were generated at the scan electrode XG1 earlier in period T3 as described above.

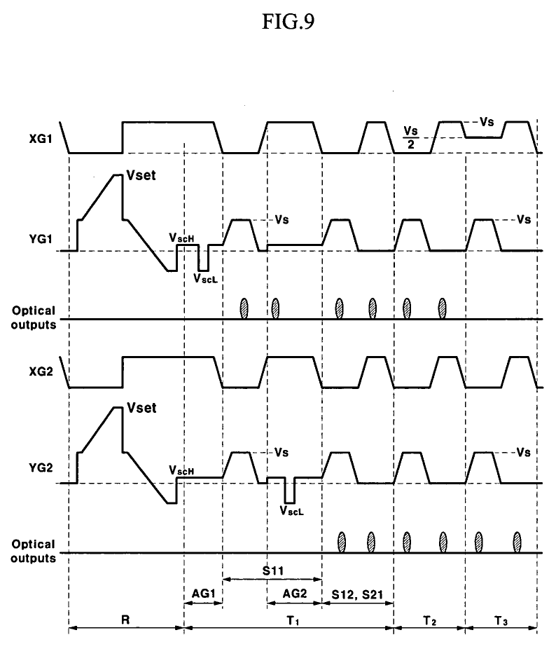

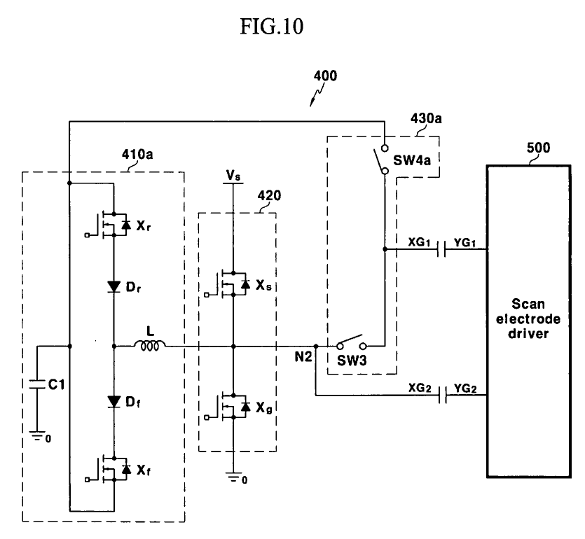

Accordingly, the brightness is corrected by applying a high level voltage of Vs of the sustain pulse to the scan and sustain electrodes in the brightness correction period T3 in the embodiments of the present invention described above. In yet another embodiment, a middle voltage between high level voltage of Vs and the low level voltage of 0V can also be used, which will now be described with reference to FIG. 9 and FIG. 10.

As shown in FIG. 9, in the brightness correction period T3, the voltage of Vs is applied to the scan electrodes YG1 and YG2 having positive wall charges that were formed at the scan electrodes YG1 and YG2 by a previous sustain discharge. Concurrently, the voltage of Vs/2 is applied to the sustain electrode XG1 and 0V is applied to the sustain electrode XG2 of the second group. Accordingly, the light-emitting cells of the second group are sustain-discharged, and the light-emitting cells of the first group are not sustain-discharged because the voltage difference between the scan electrode YG1 the sustain electrode XG1 is half the voltage of Vs (i.e., Vs/2).

Next, 0V is applied to the scan electrodes YG1 and YG2 and the voltage of Vs is applied to the sustain electrodes XG1 and XG2. Again, the light-emitting cells of the first group are not sustain discharged when 0V is applied to the scan electrode YG1 because of the remaining positive wall charges that were formed thereon.

FIG. 10 shows a schematic circuit diagram of the sustain electrode driver 400a for generating the driving waveforms of FIG. 9 that has a structure similar to the driving circuit of FIG. 8, except for the coupled state of the power recovery circuit 410a and the brightness corrector 430a.

Power recovery circuit 410a includes transistors Xr and Xf, diodes Dr and Df, an inductor L, and a power recovery capacitor C1. The capacitor C1 is charged with the middle voltage of Vs/2 and is coupled to a drain and a source of the transistor Xr. The capacitor C1 is also coupled to a first terminal of the switch SW4a of the brightness corrector 430a, and a second terminal of the switch SW4a is coupled to the sustain electrode XG1. An anode of the diode Dr is coupled to the source of the transistor Xr and its cathode is coupled to a first terminal of the inductor L. A cathode of the diode Df is coupled to the source of the transistor Xr and its anode is coupled to the first terminal of the inductor L. A second terminal of the inductor L is coupled to the node N2.

An operation of the driving circuit of FIG. 10 will now be described in reference to FIG. 9.

In the combined address/sustain period T1 and the common sustain period T2, the operation of the transistors Xs and Xg and the switches SW3 and SW4a corresponds to that of the transistors Xs and Xg and the switches SW3 and SW4 of the driving circuit of FIG. 8, and, thus, no corresponding descriptions will be provided.

The transistor Xr of the power recovery circuit 410a is turned on before the transistor Xs is turned on. Resonance then occurs between a panel capacitor, which is formed by the sustain electrodes XG1 and XG2 and the scan electrodes YG1 and YG2, and the inductor L to increase the voltages at the sustain electrodes XG1 and XG2. In a like manner, the transistor Xf is turned on before the transistor Xg is turned on. Resonance then occurs between the panel capacitor and the inductor L to decrease the voltages at the sustain electrodes XG1 and XG2.

In the brightness correction period T3, the transistor Xg is turned on to apply 0V to the node N2. At this time, the switch SW3 is turned off and the switch SW4a is turned on. Then, 0V is applied to the sustain electrode YG2 through the node N2 to perform a normal sustain discharge, and the voltage of Vs/2 charged in the capacitor C1 is applied to the sustain electrode XG1 through the switch SW4 to generate no sustain discharge.

Next, the transistor Xg and the switch SW4a are turned off and the transistor Xs and the switch SW3 are turned on to apply the voltage of Vs to the sustain electrodes XG1 and XG2. Once again, no sustain discharges occur at the scan electrode XG1 because of the remaining wall voltage of an inverted polarity as no sustain discharges were generated at the scan electrode XG1 earlier in period T3 as described above.

As previously noted, a plurality of discharge cells are divided into a plurality of groups, discharge cells of one group are addressed, and are then subsequently sustain-discharged for a predetermined time. Therefore, the time provided between the address operation and the sustain discharge operation is reduced to generate fluent sustain discharges.

While this invention has been described in connection with what is presently considered to be practical exemplary embodiments, it is to be understood that the invention is not limited to the disclosed embodiments, but, on the contrary, is intended to cover various modifications and equivalent arrangements within the spirit and scope of the appended claims.

What is claimed is:

1. A method for driving a plasma display, the plasma display including a plurality of first electrodes and a plurality of second electrodes extending along a first direction, a plurality of third electrodes extending along a second direction substantially perpendicular to the first direction, and a plurality of discharge cells that are formed by the crossing of the first electrode and the second electrode with the third electrode, the driving method comprising:
dividing the first and second electrodes into a plurality of groups such that the plurality of groups includes at least a first group and a second group;
dividing a display frame into a plurality of subfields;
dividing the subfields into a plurality of sustain periods and a plurality of address periods such that each sustain period and each address period correspond to one group of the plurality of groups,
selecting light-emitting cells from among the discharge cells of each group in the corresponding address period; and
applying a first sustain pulse to the first electrode and a second sustain pulse to the second electrode in each sustain period,
wherein the starting point of at least one sustain period is provided between two adjacent address periods,
the first and second sustain pulses applied to the first and second electrodes of the first group include a high level pulse and a low level pulse with opposite phases in a first sustain period of the plurality of sustain periods, and
the first sustain pulse applied to the first electrode of the second group does not include either the high level pulse or the low level pulse in the first sustain period.

2. The driving method of claim 1, wherein the first and second sustain pulses applied to the first and second electrodes of the first group and the second group include a high level pulse and a low level pulse of opposite phases in a second sustain period of the plurality of sustain periods.

3. The driving method of claim 1, wherein the at least one first sustain pulse applied to the first electrode of the second group is a high level pulse in the first sustain period.

4. The driving method of claim 1, wherein the first sustain pulse applied to the first electrode of the second group includes a middle level pulse having a voltage between the high level pulse and the low level pulse and a high level pulse in the first sustain period.

5. The driving method of claim 4, wherein the second sustain pulse is the low level pulse in the first sustain period when the first sustain pulse applied to the first electrode of the second group is the middle level pulse.

6. The driving method of claim 1, wherein the first electrode is a scan electrode to which a scan pulse is applied in the address period.

7. The driving method of claim 1, wherein the second electrode is a scan electrode to which a scan pulse is applied in the address period.

8. The driving method of claim 1, wherein the plurality of groups are the first group and the second group.

9. A method for driving a plasma display, the plasma display including a plurality of first electrodes and a plurality of second electrodes extending along a first direction, a plurality of third electrodes extending along a second direction substantially perpendicular to the first direction, and a plurality of discharge cells that are formed by the crossing of the first electrode and the second electrode with the third electrode, the driving method comprising:
dividing first and second electrodes into a plurality of groups;
setting light-emitting cells from among discharge cells of a first group of the plurality of groups;
sustain-discharging the light-emitting cells of the first group for a first number of times;
setting light-emitting cells from among discharge cells of a second group of the plurality of groups;
sustain-discharging the light-emitting cells of the first group and the light-emitting cells of the second group for the first number of times; and
sustain-discharging the light-emitting cells of the first group for a second number of times and the light-emitting cells of the second group for a third number of times,
wherein the sum of the first number and the second number equals the third number.

10. The driving method of claim 9, further comprising:
applying a first voltage to the first electrode of the first group and a second voltage to the first electrode of the second group; and
applying a third voltage level to the second electrodes of the first group such that light-emitting cells of the second group are sustained discharged while light-emitting cells of the first group are not sustain-discharged.

11. The driving method of claim 10, wherein the first voltage is a high level voltage and the second voltage is a low level voltage.

12. The driving method of claim 11, wherein the third voltage is a middle voltage level between the first voltage and the second voltage.

13. The driving method of claim 9, wherein the third voltage is substantially equivalent to the first voltage.

14. The driving method of claim 9, wherein the first electrode is a scan electrode to which a scan pulse is applied for setting light-emitting cells.

15. The driving method of claim 9, wherein the second electrode is a scan electrode to which a scan pulse is applied for setting light-emitting cells.

16. A plasma display comprising:
a plurality of first electrodes;
a plurality of selection circuits, each having a first terminal and a second terminal, coupled to corresponding first electrodes and selectively transmitting inputs provided by the first and second terminals to the corresponding first electrode, the plurality of selection circuits are divided into a plurality of groups including at least a first selection circuit group and a second selection circuit group;
a first switch having a first terminal coupled to a first power supply providing a first voltage for a sustain discharge and a second terminal coupled to second terminals of the selection circuits through an electrical path;
a second switch having a first terminal coupled to a second power supply providing a second voltage for a sustain discharge, and a second terminal coupled to the second terminals of the selection circuits through the electrical path; and
a third switch coupled between the first terminals of the selection circuits of the first group of selection circuits and the first power supply.

17. The plasma display of claim 16, wherein during a predetermined period:
the second switch is turned on to apply the second voltage to the corresponding first electrode through the second terminal of the selection circuit of the second group; and
the third switch is turned on to apply the first voltage to the corresponding first electrode through the first terminal of the selection circuit of the first group.

18. The plasma display of claim 17, wherein each of the plurality of selection circuits includes:
a fourth switch coupled between the first terminal and the first electrode; and
a fifth switch coupled between the second terminal and the first electrode,
wherein the fourth switch of the selection circuit of the first group is turned on and the fifth switch of the selection circuit of the second group is turned on during the predetermined period.

19. The plasma display of claim 18, further comprising:
a capacitor having a first terminal coupled to the second terminals of the selection circuits; and
a sixth switch coupled between a second terminal of the capacitor and the first terminals of the selection circuits of the first group,
wherein sixth switch is turned off during the predetermined period.

20. The plasma display of claim 18, further comprising:
a capacitor having a first terminal coupled to the second terminals of the selection circuits; and
a diode having an anode coupled to a second terminal of the capacitor and a cathode coupled to the first terminals of the selection circuits of the first group.

21. The plasma display of claim 16, further comprising:
a plurality of second electrodes extending in a direction parallel to the first electrodes; and
a plurality of third electrodes extending in a direction substantially perpendicular to the first and the second electrodes.

22. A plasma display comprising:
a plurality of first electrodes divided into a plurality of groups including at least a first group and a second group;
a first switch having a first terminal coupled to the first electrodes of the first group;
a sustain driver having an output terminal coupled to both the first terminal of the first switch and the first electrodes of the second group, the sustain driver alternately outputting a first voltage and a second voltage in a sustain period; and
a second switch having a first terminal coupled to the first electrodes of the first group and a second terminal coupled to a power supply of the sustain driver.

23. The plasma display of claim 22, wherein the sustain driver further comprises:
a third switch coupled between a first power supply providing the first voltage and the output terminal; and
a fourth switch coupled between a second power supply providing the second voltage and the output terminal,
wherein the second terminal of the second switch is coupled to the first power supply.

24. The plasma display of claim 23, wherein:
the first switch is turned off and the fourth switch is turned on to apply the second voltage to first electrodes of the second group; and
the second switch is turned on to apply the first voltage to the first electrodes of the first group.

25. The plasma display of claim 22, wherein the sustain driver further comprises:
a third switch coupled between a first power supply providing the first voltage and the output terminal;
a fourth switch coupled between a second power supply providing the second voltage and the output terminal; and
a power recovery circuit coupled to the output terminal, the power recovery circuit including a power recovery capacitor and an inductor,
wherein the second terminal of the second switch is coupled to the power recovery capacitor.

26. The plasma display of claim 23, wherein:
the first switch is turned off and the fourth switch is turned on to apply the second voltage to the first electrodes of the second group; and
the second switch is turned on to apply the first voltage to the first electrodes of the first group.

27. The plasma display of claim 22, further comprising:
a plurality of second electrodes extending in a direction parallel to the first electrodes; and
a plurality of third electrodes extending in a direction substantially perpendicular to the first and second electrodes.
